(19) United States
(12) Patent Application Publication
(10) Pub. No.: US 2004/0263402 A1
(43) Pub. Date: Dec. 30, 2004

(54) Planar antenna having adjustable mounting portion

(76) Inventors: Zhen-Da Hung, Tu-Chen (TW); Lung-Sheng Tai, Tu-Chen (TW); Hsien-Chu Lin, Tu-Chen (TW)

Correspondence Address: WEI TE CHUNG, FOXCONN INTERNATIONAL, INC., 1650 MEMOREX DRIVE, SANTA CLARA, CA, 95050, US

(21) Appl. No.: 10/877,722

(22) Filed: Jun. 25, 2004

(30) Foreign Application Priority Data
Jun. 25, 2003 (TW) 92211555

(51) Int. Cl. H01Q 1/24

(52) U.S. Cl. 343/702

(57) ABSTRACT

A planar antenna (1) includes a radiation portion (3) and a ground portion (2). The radiation portion includes a printed circuit board (31) and radiating elements (32) disposed on one surface of the printed circuit board. The ground portion includes a horizontal plate secured on an end portion of the printed circuit board and two side walls (23, 24) extending vertically from the horizontal plate. A long and narrow through hole (21) is defined in the horizontal plate with two semicircumferential edges and two straight edges between the two semicircumferential edges. One end of the horizontal plate fixed on one end of the printed circuit board.

### BACKGROUND OF THE INVENTION

1. Field of the Invention

The present invention relates to a planar antenna, and in particular to a planar antenna employed in a laptop computer.

2. Description of the Prior Art

One conventional planar antenna is disclosed in U.S. Pat. No. 6,486,834, which provides a printed circuit board having opposite first and second surfaces, a metal sheet attached to the first surface of the printed circuit board, a flat antenna mounted on the first surface of the printed circuit board, and a signal transmitting cable having a core wire electrically connecting with the antenna, and a ground shield surrounding the core wire electrically connecting with the metal sheet. The printed circuit board is fixed to a metal hinge base of the portable electronic device at a position such that the metal sheet electrically connects with metal hinge base.

However the connection between the printed circuit board and the metal hinge base of the portable electronic device is provided only by a screw. After the planar antenna is fixed, the planar antenna probably rotates around the screw because of outside force acted on the planar antenna. The performance of sending signals or receiving signals is influenced when the planar antenna is declining from the preconcerted position.

Hence, an improved planar antenna is desired to overcome the above-mentioned shortcomings of the existing planar antennas.

### BRIEF SUMMARY OF THE INVENTION

It is therefore an object of the present invention to provide a planar antenna which prevents the planar antenna moving around a fixed portion of the planar antenna.

In order to achieve the above object, an aspect of the present invention is a planar antenna comprising a radiation portion and a ground portion. The radiation portion includes a printed circuit board and radiating elements disposed on one surface of the printed circuit board. The ground portion includes a horizontal plate secured on an end portion of the printed circuit board and two side walls extending vertically from the horizontal plate.

A second object of the present invention is to provide a planar antenna which can be fixed freely in an electronic device.

In order to achieve the second object, another aspect of the present invention is a planar antenna comprising a long and narrow through hole defined in the horizontal plate with two semicircumferential edges and two straight edges between the two semicircumferential edges.

Other objects, advantages and novel features of the invention will become more apparent from the following detailed description of preferred embodiments when taken in conjunction with the accompanying drawings.

### BRIEF DESCRIPTION OF THE DRAWINGS

FIG. 1 is a perspective view of a planar antenna of the present invention; and

FIG. 2 is an exploded view of the planar antenna of FIG. 1.

### DETAILED DESCRIPTION OF THE INVENTION

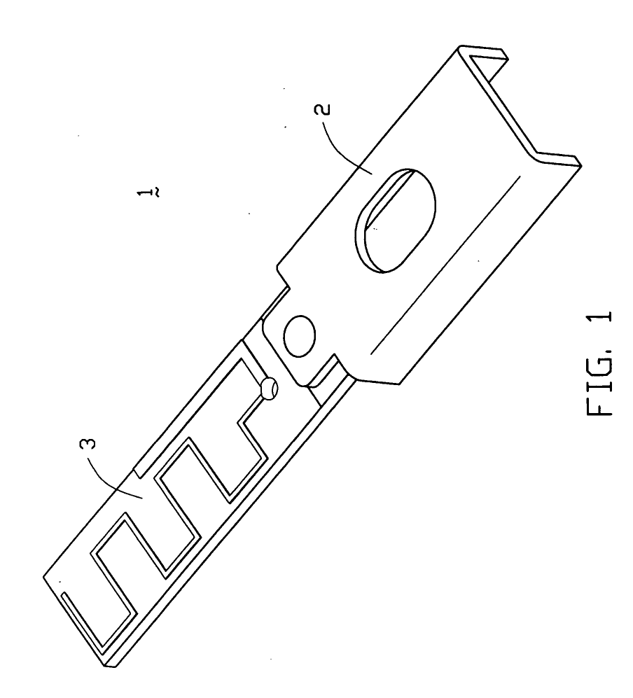

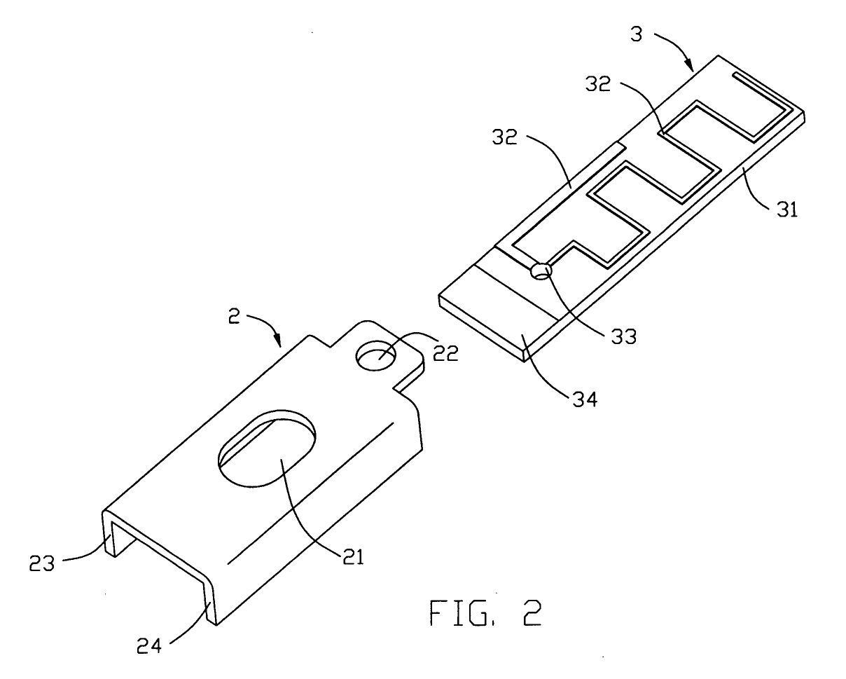

A planar antenna 1 of the present invention is shown in FIG. 1 and FIG. 2, which has a radiation portion 3 and a ground portion 2. The radiation portion 3 includes a printed circuit board 31 and radiating elements 32 disposed on one surface of the printed circuit board 31. A feed-in hole 33 is defined in a crossing of the radiating elements 32. The ground portion 2 includes a horizontal plate (not labeled) secured on an end portion of the printed circuit board 31 and two side walls 23, 24 extending downwardly and vertically from two opposite sides of the horizontal plate. A long and narrow through hole 21 is defined in the horizontal plate with two semicircumferential edges and two straight edges between the two semicircumferential edges.

The ground portion 2 includes a hole 22 at an end near the radiation portion 3, and the radiation portion 3 includes a connection portion 34 at the end near the ground portion 2. The connection portion 34 is made of solder material and disposed on the surface of the printed circuit board 31. The hole 22 is filled with solder material. When the ground portion 2 is soldered onto the radiation portion 3, the connection portion 34 is soldered with the solder material in the hole 22. Therefore the ground portion 2 is fixed stably on the radiation portion 3.

The planar antenna 1 is fixed in an electronic device (not shown) by a screw (not shown). The screw goes through the long and narrow through hole 21 to the electronic device. When the planar antenna 1 is fixed in different conditions, the screw can be placed on different position of longitudinal axis of the long and narrow through hole 21. After the screw is fixed, the side walls 23, 24 engage with corresponding portions of the electronic device in order to prevent the planar antenna 1 rotating around the screw.

It is to be understood, however, that even though numerous, characteristics and advantages of the present invention have been set forth in the foregoing description, together with details of the structure and function of the invention, the disclosed is illustrative only, and changes may be made in detail, especially in matters of shape, size, and arrangement of parts within the principles of the invention to the full extent indicated by the broad general meaning of the terms in which the appended claims are expressed.

What is claimed is:

1. A planar antenna comprising:
a printed circuit board;
radiating elements disposed on one surface of said printed circuit board; and
a ground portion having a horizontal plate with a through hole and at least two side walls extending downwardly and vertically from two opposite sides of said horizontal plate, one end of said horizontal plate being fixed on one end of said printed circuit board.

2. The planar antenna of claim 1, wherein said radiating elements are electroplated on said one surface of said printed circuit board.

3. The planar antenna of claim 2, wherein said through hole is long and narrow, longitudinal axis of said through hole being coincident with longitudinal axis of said ground portion.

4. The planar antenna of claim 3, wherein said through hole comprises two semicircumferential edges and two straight edges between the two semicircumferential edges.

5. A planar antenna comprising:
a printed circuit board;
radiating elements disposed on one surface of said printed circuit board; and
a ground portion having a horizontal plate with a long and narrow through hole and at least two side walls extending from said horizontal plate, one end of said horizontal plate being fixed on one end of said printed circuit board.

6. The planar antenna of claim 5, wherein said long and narrow through hole comprises two semicircumferential edges and two straight edges between the two semicircumferential edges.

7. The planar antenna of claim 6, wherein said direction walls are vertical to said horizontal plate.

8. A planar antenna comprising:
a printed circuit board defining a longitudinal direction;
radiating elements disposed on one surface of said printed circuit board; and
a ground portion attached to the printed circuit board and having a horizontal plate with a slot extending through said ground portion in a vertical direction and also extending with a distance along said longitudinal direction.

9. The planar antenna of claim 8, wherein said ground portion defines a U-shaped section receiving one end of said printed circuit board where the ground portion and the printed circuit board are fastened together.
